(19) United States
(12) Patent Application Publication
(10) Pub. No.: US 2024/0227727 A1
(43) Pub. Date: Jul. 11, 2024

(54) METHODS AND SYSTEMS FOR AN ANTI-THEFT DEVICE

(71) Applicant: Dana Heavy Vehicle Systems Group, LLC, Maumee, OH (US)

(72) Inventors: Pritesh Ashok DOSHI, Pune (IN); Saket KALE, Pune (IN); Sandeep NARGIDE, Pune (IN); Vijay KADAM, Pune (IN); Anand WAKODE, Pune (IN)

(21) Appl. No.: 18/151,348

(22) Filed: Jan. 6, 2023

(51) Int. Cl. B60R 25/045; B60R 25/10

(52) U.S. Cl. CPC B60R 25/045; B60R 25/1004; B60R 2025/1013

(57) ABSTRACT

Systems are provided for an anti-theft device. In one example, a method includes operating an anti-theft device at a coupling between a traction motor and an axle housing to signal to a controller to activate an alarm in response to unauthorized actuation of the coupling. The anti-theft device comprises a component communicatively coupled to the controller.

### TECHNICAL FIELD

The present description relates generally to an anti-theft device of a vehicle.

### BACKGROUND AND SUMMARY

Electric vehicles and their associated parts may be still relatively expensive compared to internal combustion engine (ICE) vehicles and their associated parts due to lower infiltration into a vehicle market. These relatively high prices may encourage people to steal parts from electric vehicles. As such, there is a demand for improved anti-theft devices configured to mitigate theft of electric vehicle components.

Previous examples of anti-theft devices may include devices specifically configured to mitigate ease of theft of specific electric vehicle components, such as the electric motor. One such example is shown in CN 211844700. Therein, a shell and cover are coupled together and used to increase a difficulty of removing the electric motor without vehicle operator permission. A drive shaft of the electric motor passes through an opening of the cover. Thus, the motor may not be removed without removing the anti-theft device.

However, the inventors have identified some issues with the example shown in CN 211844700. As one example, the anti-theft device comprises features that overly complicate maintenance of the electric motor when maintenance is desired. This leads to higher repair costs and longer wait times, which may be inconvenient to the vehicle operator and/or the repair service.

In one example, the issues described above may be at least partially solved by a method for operating an anti-theft device at a coupling between a traction motor and an axle housing to signal to a controller to activate an alarm in response to unauthorized actuation of the coupling.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE FIGURES

The above, as well as other advantages of the present disclosure, will become readily apparent to those skilled in the art from the following detailed description when considered in light of the accompanying drawings in which:

FIG. 1 is a schematic depiction of an example vehicle powertrain, according to an embodiment of the present disclosure;

FIGS. 2A and 2B show a first embodiment of an anti-theft device, according to an embodiment of the present disclosure;

FIG. 2C shows an example of a lock of the anti-theft device

FIGS. 3A and 3B show a second embodiment of the anti-theft device, according to an embodiment of the present disclosure;

FIGS. 4A and 4B show a third embodiment of the anti-theft device, according to an embodiment of the present disclosure;

FIGS. 5A and 5B show a fourth embodiment of the anti-theft device, according to an embodiment of the present disclosure;

FIGS. 6A and 6B show a fifth embodiment of the anti-theft device, according to an embodiment of the present disclosure; and

FIG. 7 shows a method for operating the anti-theft device, according to an embodiment of the present disclosure.

### DETAILED DESCRIPTION

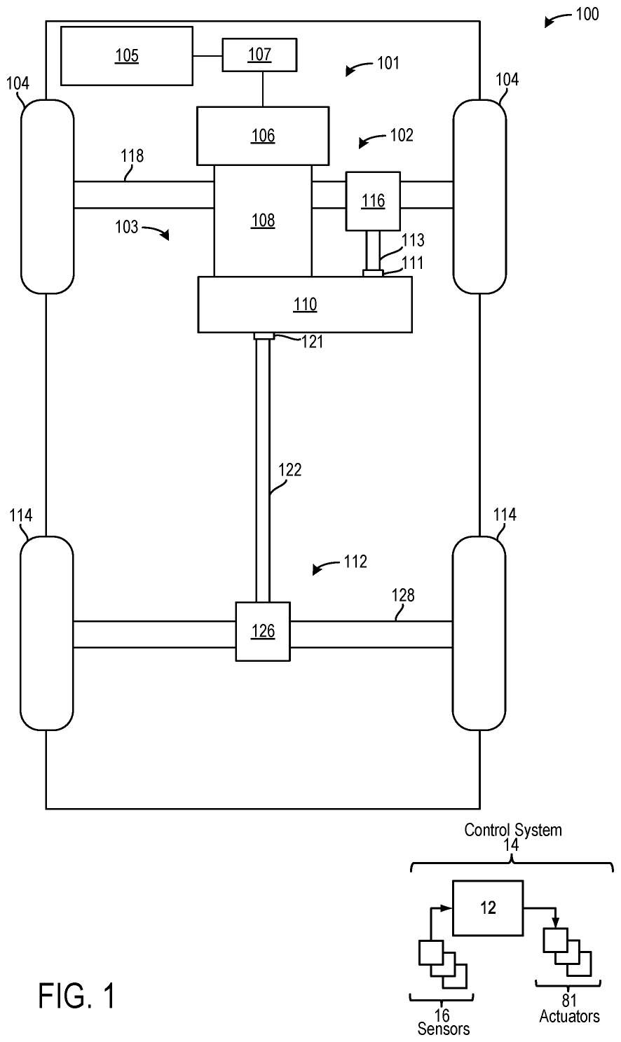

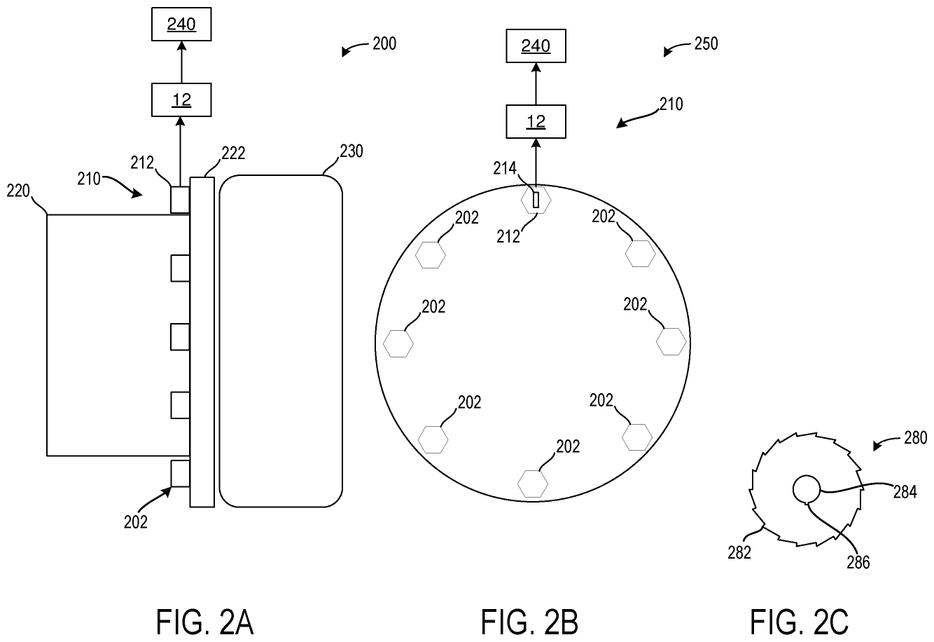

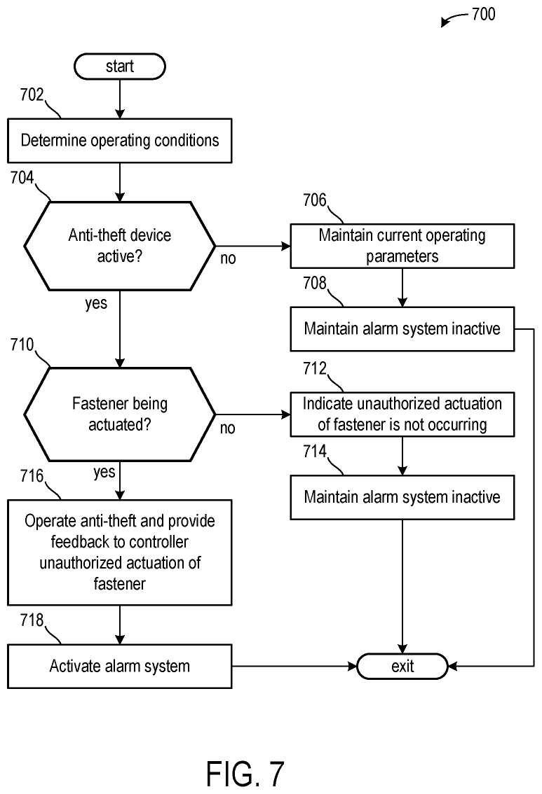

The following description relates to a coupling element. Herein, the coupling device is an anti-theft device of a vehicle, such as the example vehicle shown in FIG. 1. FIGS. 2A-6B illustrate various embodiments of the anti-theft device. The anti-theft device may couple and/or interact with one or more fasteners coupling the electric motor to an axle housing. A method for operating the anti-theft device is shown in FIG. 7.

FIGS. 1-6B show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example. It will be appreciated that one or more components referred to as being “substantially similar and/or identical” differ from one another according to manufacturing tolerances (e.g., within 1-5% deviation).

Turning now to FIG. 1, a vehicle 100 is shown comprising a powertrain 101 and a drivetrain 103. The powertrain comprises a prime mover 106 and a transmission 108. The prime mover 106 may be an internal combustion engine or a traction motor (e.g., an electric motor), for example, and is operated to provide rotary power to the transmission 108. The transmission 108 may be any type of transmission, such as a manual transmission, an automatic transmission, or a continuously variable transmission. The transmission 108 receives the rotary power produced by the prime mover 106 as an input and outputs rotary power to the drivetrain 103 in accordance with a selected gear or setting.

The prime mover 106 may be powered via energy from an energy storage device 105. In one example, the energy storage device 105 is a battery configured to store electrical energy. An inverter 107 may be arranged between the energy storage device 105 and the prime mover 106 and configured to adjust direct current (DC) to alternating current (AC).

The vehicle 100 may be a commercial vehicle, light, medium, or heavy duty vehicle, a passenger vehicle, an off-highway vehicle, and sport utility vehicle. Additionally or alternatively, the vehicle 100 and/or one or more of its components may be in industrial, locomotive, military, agricultural, and aerospace applications. In one example, the vehicle 100 is an electric vehicle.

In some examples, such as shown in FIG. 1, the drivetrain 103 includes a first axle assembly 102 and a second axle assembly 112. The first axle assembly 102 may be configured to drive a first set of wheels 104, and the second axle assembly 112 may be configured to drive a second set of wheels 114. In one example, the first axle assembly 102 is arranged near a front of the vehicle 100 and thereby comprises a front axle, and the second axle assembly 112 is arranged near a rear of the vehicle 100 and thereby comprises a rear axle. The drivetrain 103 is shown in a four-wheel drive configuration, although other configurations are possible. For example, the drivetrain 103 may include a front-wheel drive, a rear-wheel drive, or an all-wheel drive configuration. Further, the drivetrain 103 may include one or more tandem axle assemblies. As such, the drivetrain 103 may have other configurations without departing from the scope of this disclosure, and the configuration shown in FIG. 1 is provided for illustration, not limitation. Further, the vehicle 100 may include additional wheels that are not coupled to the drivetrain 103.

In some four-wheel drive configurations, such as shown in FIG. 1, the drivetrain 103 includes a transfer case 110 configured to receive rotary power output by the transmission 108. A first driveshaft 113 is drivingly coupled to a first output 111 of the transfer case 110, while a second driveshaft 122 is drivingly coupled to a second output 121 of the transfer case 110. The first driveshaft 113 (e.g., a front driveshaft) transmits rotary power from the transfer case 110 to a first differential 116 of the first axle assembly 102 to drive the first set of wheels 104, while the second driveshaft 122 (e.g., a rear driveshaft) transmits the rotary power from the transfer case 110 to a second differential 126 of the second axle assembly 112 to drive the second set of wheels 114. For example, the first differential 116 is drivingly coupled to a first set of axle shafts 118 coupled to the first set of wheels 104, and the second differential 126 is drivingly coupled to a second set of axle shafts 128 coupled to the second set of wheels 114. It may be appreciated that each of the first set of axle shafts 118 and the second set of axle shafts 128 may be positioned in a housing.

In some examples, additionally or alternatively, the vehicle 100 may be a hybrid vehicle including both an engine an electric machine each configured to supply power to one or more of the first axle assembly 102 and the second axle assembly 112. For example, one or both of the first axle assembly 102 and the second axle assembly 112 may be driven via power originating from the engine in a first operating mode where the electric machine is not operated to provide power (e.g., an engine-only mode), via power originating from the electric machine in a second operating mode where the engine is not operated to provide power (e.g., an electric-only mode), and via power originating from both the engine and the electric machine in a third operating mode (e.g., an electric assist mode). As another example, one or both of the first axle assembly 102 and the second axle assembly 112 may be an electric axle assembly configured to be driven by an integrated electric machine.

Vehicle 100 may further include a control system 14. Control system 14 is shown receiving information from a plurality of sensors 16 (various examples of which are described herein) and sending control signals to a plurality of actuators 81 (various examples of which are described herein). As one example, sensors 16 may include a proximity sensor and/or a multimeter coupled an anti-theft device arranged adjacent to an interface between the prime mover 106 and the transmission housing 108 and/or an axle housing.

In some examples, additionally or alternatively, the anti-theft device may be at the coupling be arranged in other locations with relation to the prime mover 106. For example, the prime mover 106 may be physically coupled to a wheel hub, wherein the anti-theft device may be at the coupling between the prime mover 106 and the wheel hub. That is to say, the anti-theft device may be positioned at a coupling between the prime mover 106 and a location of a driveline.

Controller 12 may be configured as a conventional microcomputer including a microprocessor unit, input/output ports, read-only memory, random access memory, keep alive memory, a controller area network (CAN) bus, etc. Controller 12 may be configured as a powertrain control module (PCM). The controller may be shifted between sleep and wake-up modes for additional energy efficiency. The controller may receive input data from the various sensors, process the input data, and trigger the actuators in response to the processed input data based on instruction or code programmed therein corresponding to one or more routines.

FIGS. 2A-6B show various examples of an anti-theft device. The anti-theft device may interact with one or more of a plurality of fasteners 202 coupling an electric motor 220 to an axle housing 230. In one example, the axle housing 230 is identical to the transmission housing 108 of FIG. 1. The electric motor 220 may be identical to the prime mover 106 of FIG. 1, in one example. The plurality of fasteners 202 may extend through a flange 222 of the electric motor 220 and thread with a complementary threaded portion of the axle housing 230.

Turning now to FIGS. 2A and 2B, they show a side view 200 and a front view 250 of a first embodiment of an anti-theft device 210 interacting with the electric motor 220 and the axle housing 230, respectively. The anti-theft device 210 is integrally arranged with one of the plurality of fasteners. In one example, the anti-theft device 210 is a fastener 212 comprising a slot 214 and corresponding lock in the axle housing 230. In one example, the lock may include a deadbolt or other element configured to protrude into a slot and immobilize the fastener 212 when locked. When unlocked, the deadbolt may retract from the slot and allow the fastener 212 to be actuated (e.g., rotated, turned, hit/contacted, or tampered with in another way) without sending a signal to the controller 12. In one example, the slot 214 is a keyhole or other specialized shape demanding a complementary tool to unlock the lock. A key, such as a vehicle key inserted into an ignition of the vehicle or a different key, may be inserted into the slot to unlock the lock. By doing this, the fastener 212 of the plurality of fasteners 202 integrally housing the anti-theft device 210 may be uncoupled (e.g., rotated) similar to the remaining fasteners.

In some examples, the anti-theft device 210 may include where each of the plurality of fasteners 202 is locked using a ratchet arrangement. The ratchet arrangement may be unlocked via a key and allow a user to uncouple the plurality of fasteners 202 via a wrench, a socket, or other device.

FIG. 2C shows an example fastener 280 which may be a non-limiting example of one of the plurality of fasteners 202 and/or the fastener 212. The fastener 280 may include a ratchet mechanism comprising a plurality of teeth 282. Each of the teeth extend perpendicularly from a step to which they are coupled. Each of the teeth may be angled at less than 90 degrees relative to one another. At a center of the ratchet mechanism there may be an opening 284 comprising a keyhole 286. The opening 284 in combination with the keyhole 286 may receive a corresponding key to unlock the fastener 280 from a locking device.

The anti-theft device 210 may be coupled to the controller 12. The anti-theft device 210 may send a signal to the controller 12 when the fastener 212 with which the anti-theft device 210 is integrally coupled is actuated without unlocking the lock of the anti-theft device 210. The controller 12 may signal to an alarm system 240 to activate an alarm in response to receiving a signal from the anti-theft device 210. The alarm may include a beep, honk, or other noise generated by the alarm system 240. In one example, the alarm may be a silent alarm sent to authorities, the vehicle owner, and the like. The alarm may further include a message, such as a short message service (SMS), sent to a vehicle operator device (e.g., a phone, laptop, etc.), sent to a local authority (e.g., a police station), a fleet owner. Additionally or alternatively, a notification may be displayed on a vehicle display when the vehicle is started. In some examples, the anti-theft device 210 may resist actuation of the fastener 212 and/or one or more of the plurality of fasteners 202 in response to detecting tampering of the fastener 212 or one or more of the plurality of fasteners 202. For example, if the lock is not unlocked, any actuation of the fastener 212 or plurality of fasteners 202 may be determined as tampering and/or unauthorized actuation. The lock may block the fastener 212 from being actuated. That is to say, a coupling between the electric motor 220 and the axle housing 230 may be immobilized via the anti-theft device 210.

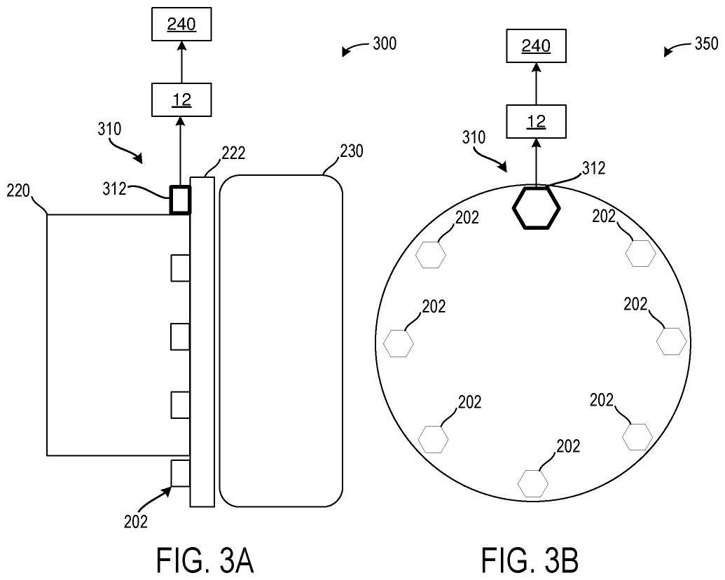

Turning now to FIGS. 3A and 3B, they show a side view 300 and a front view 350 of a second embodiment of an anti-theft device 310 interacting with the electric motor 220 and the axle housing 230, respectively. The anti-theft device 310 may be configured as a fastener 312. The fastener 312 may be differentiated from the plurality of fasteners 202 in that the fastener 312 may be torqued at an upper threshold torque and the plurality of fasteners 202 may be torqued at a lower threshold torque. In one example, the upper threshold torque is greater than 500 Nm and the lower threshold torque is less than 100 Nm. In one example, the upper threshold torque is equal to 800 Nm. In one example, the upper threshold torque is set to a value at which a user may not loosen the fastener 312 with a standard tool or gain the leverage to loosen the fastener when the vehicle is on the ground. At any rate, the fastener 312 is torqued to a torque higher than the plurality of fasteners. Additionally or alternatively, the fastener 312 may be removed via a tool only when the vehicle is lifted (e.g., moved off and above a ground upon which the vehicle may drive).

To accommodate the additional torque, the fastener 312 may be larger than each of the plurality of fasteners 202. In some examples, additionally or alternatively, the fastener 312 may be one of a plurality of anti-theft devices, wherein each of the plurality of anti-theft devices may be larger fasteners relative to the plurality of fasteners 202.

The anti-theft device 310 may be coupled to the controller 12. The anti-theft device 310 may send a signal to the controller 12 when an attempt to manipulate the fastener 312 is sensed when the vehicle is on the ground. Additionally or alternatively, the tool used to remove the fastener 312 may reduce its torque at a determined rate. If a hand tool or different tool is used, it may not actuate the anti-theft device 310 or actuate it in a manner such that a rate of torque decrease is different than the determined rate. In response to the rate of torque decrease being different than the determined rate, the anti-theft device may send the signal to the controller 12, after which the controller may signal to the alarm system to activate the alarm.

In one example, the tool may be a specialized tool with a size and strength configured to release the fastener 312. When the vehicle is on the ground, the tool may not fit between an underbody of the vehicle and the ground. Additionally or alternatively, the tool may not gain sufficient leverage to actuate the fastener 312 when the vehicle is on the ground. In one example, smaller tools may not comprise sufficient strength to release the fastener 312 or to release the fastener 312 at the determined rate.

In one example, additionally or alternatively, the fastener 312 may include a different head shape than the plurality of fasteners 202. In the example of FIGS. 3A and 3B, the fastener 312 and the plurality of fasteners 202 comprises a head shaped as a hexagon. However, in one example, the fastener 312 may comprise a head shape shaped differently than a hexagon, such as a multi-point star shape, a heptagon shape, an octagon shape, or other shape different than a hexagon.

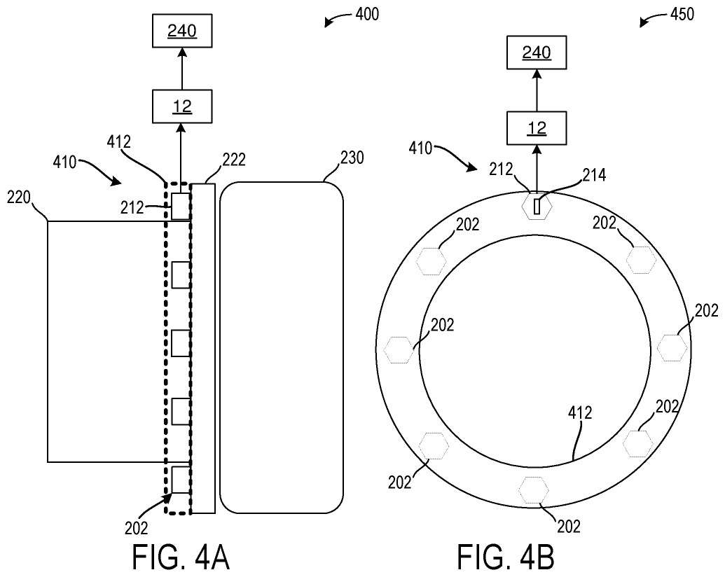

Turning now to FIGS. 4A and 4B, they show a side view 400 and a front view 450 of a third embodiment of an anti-theft device 410 interacting with the electric motor 220 and the axle housing 230, respectively. The anti-theft device 410 includes the fastener 212 and the slot 214. The anti-theft device 410 further includes a cover 412 configured to cover each of the plurality of fasteners 202 except for the fastener 212. The cover 412 is locked in place with the fastener 212 and removable when the lock of the fastener 212 is unlocked and the fastener 212 removed.

The cover 412 may comprise an opening that exposes the fastener 212. In one example, an elongated socket or other tool may be used to extend through the opening to actuate the fastener 212. A key or other device may be inserted through the opening and into the slot 214 of the fastener 212 to unlock the lock thereof. Additionally or alternatively, the anti-theft device 210 may not send a signal to the controller 12 if the lock is unlocked and the fastener 212 is loosened thereafter. The cover 412 may be removed once the fastener 212 is removed and a user may access the remaining of the plurality of fasteners 202 while the alarm system 240 is inactive.

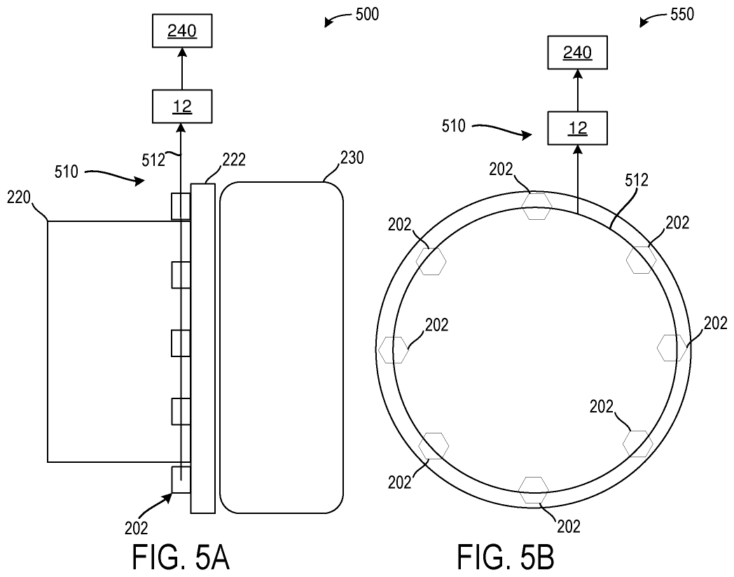

Turning now to FIGS. 5A and 5B, they show a side view 500 and a front view 550 of a fourth embodiment of an anti-theft device 510 interacting with the electric motor 220 and the axle housing 230, respectively. The anti-theft device 510 may include a conductive wire 512. The conductive wire 512 may be configured as a contact breaker string passing through holes provided on mounting bolt heads of the flange 222. The conductive wire 512 may be wound across the plurality of fasteners 202 and electrically coupled to the controller 12. The anti-theft device 510 may be disabled via removal/disconnection of the conductive wire 512 from the controller 12 and or other methods of authorized removal/disconnection. As such, if a fastener of the plurality of fasteners 202 is actuated without disconnecting of the wire 512 from the controller 12, the controller 12 may signal to the alarm system 240 to activate the alarm.

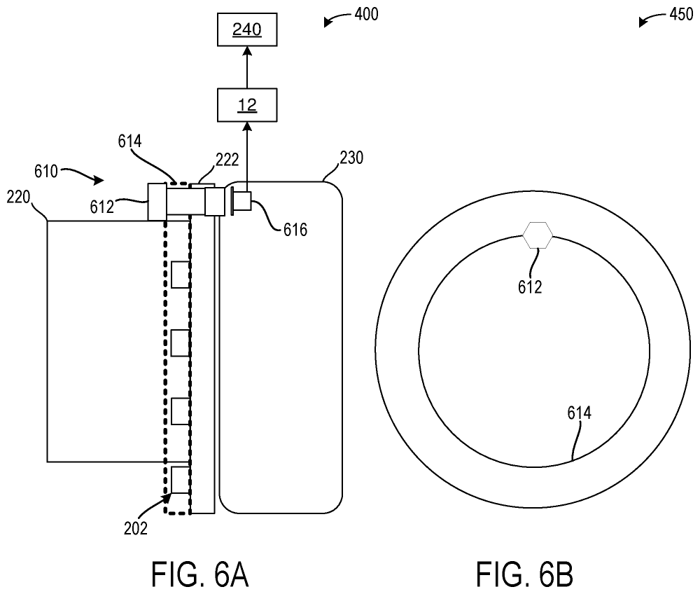

Turning now to FIGS. 6A and 6B, they show a side view 600 and a front view 650 of a fifth embodiment of an anti-theft device 610 interacting with the electric motor 220 and the axle housing 230, respectively. The anti-theft device 610 may include a fastener 612, different than each of the plurality of fasteners 202. The fastener 612 may be sized differently than each of the plurality of fasteners 202. The fastener 612 may secure a cover 614 against the flange 222. The cover 614 may cover and block access to each of the plurality of fasteners 202. The fastener 622 may extend and be accessible from a location outside of an outer surface of the cover 614.

The anti-theft device 610 may further comprise a sensor 616. In one example, the sensor 616 is a proximity sensor. The sensor 616 may sense a proximity of the fastener 612 to the axle housing 230. If the fastener 612 is actuated and the anti-theft device 610 is active, then the sensor 616 may provide feedback to the controller 12 indicating a distance of the fastener 612 is greater than a threshold distance. When the distance is greater than the threshold distance and the fastener 612 is further away from the axle housing 230, the alarm system 240 may be activated and an alarm may be audibly operated. If the sensor 616 is disabled via a key-fob or manually disconnect at the controller 12 via a user, then the sensor 616 may not provide a signal to the controller 12. The fastener 612 may be removed, which may release the cover 614 and expose the plurality of fasteners 202.

In this way, FIGS. 2A-6B show an anti-theft device comprising a component in communicative coupling with a controller. The communicative coupling may be via a wired connection or a wireless connection, such as Bluetooth, Wi-Fi, or the like. In response to the component not being unlocked and a coupling between an electric motor and an axle housing being tampered with, an alarm may sound. Additionally or alternatively, the anti-theft device may resist manipulation of the coupling such that separation of the electric motor and the axle housing may not occur.

Turning now to FIG. 7, it shows a method 700 for operating the anti-theft device. Instructions for carrying out method 700 may be executed by a controller based on computer-readable instructions stored on a memory of the controller and in conjunction with signals received from sensors of the vehicle system, such as the sensors described above with reference to FIGS. 1-6B. The controller may employ actuators of the vehicle system to adjust vehicle operation, according to the method described below.

The method 700 may begin at 702, which includes determining operating conditions. Operating conditions may include determining one or more of if a vehicle is on/off, if the vehicle is locked, if an occupant is present in the vehicle, and the like.

At 704, the method 700 may include determining if an anti-theft device is active. The anti-theft device may be disabled in response to a specific tool actuating a fastener of the anti-theft device at a threshold rate, a wire of the anti-theft device being disconnected from the controller, a sensor of the anti-theft device being disabled, a key or other device unlocking a lock of the anti-theft device, and/or the controller receiving a signal from an unlocking device to disable. The unlocking device may be a vehicle key, a key fob, a mobile device (e.g., a phone, a tablet, a laptop, etc.), a button in a vehicle cabin interior, and/or an option presented on a display device in the vehicle cabin interior. In this way, the anti-theft device may be unlocked manually and/or via an electronic device.

If the anti-theft device is inactive (NO at 704), then at 706, the method 700 may include maintaining current operating parameters.

At 708, the method 700 may include maintaining the alarm system inactive. As such, an alarm may not be activated. In one example, a user may actuate fasteners and decouple the electric motor from the axle housing without the alarm system activating an alarm.

If the anti-theft device is active (YES at 704), then at 710, the method 700 determining if one or more fasteners are being actuated. In one example, actuating the fastener(s) may include rotating, turning, twisting, or other action where a force is applied to the fastener. The anti-theft device may signal to the controller if one or more fasteners are being actuated via the wire grounding a circuit, the proximity sensor sensing the fastener or fasteners being outside a threshold distance of the axle housing, and a rate of torque decrease being different than a threshold rate.

If the fastener is not being actuated (NO at 710), then at 712, the method 700 may include indicating unauthorized actuation of fastener is not occurring.

At 714, the method 700 may include maintaining the alarm system inactive. As such, an audible or silent alarm may not be activated.

Returning to 710, if a fastener is being actuated (YES at 710), then at 716, the method 700 may include operating the anti-theft device to provide feedback to the controller indicating unauthorized actuation of the fastener. Thus, in one example, the anti-theft device is still active and a fastener was actuated. Additionally or alternatively, operating the anti-theft device may further include immobilizing the fastener or other coupling between the electric motor and the axle housing to block separation of the two.

At 718, the method 700 may include activating the alarm system. The alarm system may include one or more of an audible alarm and a silent alarm. The audible alarm may include a determined decibel sound for user within a threshold distance of the vehicle to hear the audible alarm. In one example, the determined decibel sound may be 100 decibels. Additionally or alternatively, the alarm system may include a silent alarm, which may send a notification to one or more of a vehicle owner, a local authority, a vehicle manufacturer, or other service.

The disclosure provides support for a method including operating an anti-theft device at a coupling between a traction motor and a driveline to signal to a controller to activate an alarm in response to unauthorized actuation of the coupling. A first example of the method further includes where deactivating the anti-theft device by decoupling a wire from the controller, wherein the wire extends around a plurality of fasteners physically coupling the traction motor to the driveline. A second example of the method, optionally including the first example, further includes where deactivating the anti-theft device by disabling a proximity sensor coupled to the controller and configured to sense a proximity of a fastener physically coupled the traction motor to the driveline. A third example of the method, optionally including one or more of the previous examples, further includes where operating the anti-theft device further comprises detecting actuation of the coupling and immobilizing the coupling responsive to tampering via a lock that is in a locked position. A fourth example of the method, optionally including one or more of the previous examples, further includes where deactivating the anti-theft device in response to a rate at which a fastener is actuated matching a threshold rate. A fifth example of the method, optionally including one or more of the previous examples, further includes where operating the anti-theft device further comprises detecting tampering of the coupling in response to fasteners of the coupling being actuated when a vehicle comprising the traction motor is on a ground.

The disclosure provides further support for a system including an axle housing, a traction motor coupled to the axle housing via a plurality of fasteners, an anti-theft device integrally arranged with the plurality of fasteners, and a controller with computer-readable instructions stored on memory thereof that cause the controller to activate an alarm system in response to receiving a signal from the anti-theft device. A first example of the system further includes where the anti-theft device comprises a fastener and a lock, wherein the fastener comprises a slot configured to receive a key to unlock the lock and block the signal from the anti-theft device to the controller, and wherein the fastener is different than each of the plurality of fasteners. A second example of the system, optionally including the first example, further includes where the anti-theft device comprises a fastener sized differently than each of the plurality of fasteners, and wherein the fastener is torqued to an upper threshold torque with a different tool relative to the plurality of fasteners. A third example of the system, optionally including one or more of the previous examples, further includes where the anti-theft device comprises a cover configured to block access to the plurality of fasteners, the cover comprising an opening providing access to a fastener of the anti-theft device, where the fastener of the anti-theft device is different than each of the plurality of fasteners. A fourth example of the system, optionally including one or more of the previous examples, further includes where the fastener comprises a key hole or is larger than each of the plurality of fasteners. A fifth example of the system, optionally including one or more of the previous examples, further includes where the anti-theft device comprises a wire wrapped around the plurality of fasteners and electrically coupled to the controller. A sixth example of the system, optionally including one or more of the previous examples, further includes where the instructions further cause the controller to maintain the alarm system inactive in response to the wire being decoupled from the controller, and wherein the controller receives the signal and activates the alarm system when one or more of the plurality of fasteners is actuated while the wire is coupled to the controller. A seventh example of the system, optionally including one or more of the previous examples, further includes where the anti-theft device comprises a proximity sensor configured to sense a proximity of a fastener of the anti-theft device to the axle housing. An eighth example of the system, optionally including one or more of the previous examples, further includes where the instructions further cause the controller to maintain the alarm system inactive in response to the proximity sensor being disabled and the fastener being actuated.

The disclosure provides additional support for a system including an axle housing, a traction motor coupled to the axle housing via a plurality of fasteners, an anti-theft device integrally arranged with the plurality of fasteners and a controller with computer-readable instructions stored on memory thereof that cause the controller to activate an alarm system in response to receiving a signal from the anti-theft device, and maintain the alarm system inactive in response to the anti-theft device being disabled. A first example of the system further includes where the anti-theft device is disabled via one or more of a vehicle key, a key fob, a mobile device, a button in a vehicle interior, and an option provided by a display device of the vehicle. A second example of the system, optionally including the first example, further includes where the anti-theft device comprises a component communicatively coupled to the controller, wherein the component is a fastener, a wire, or a proximity sensor. A third example of the system, optionally including one or more of the previous examples, further includes where the anti-theft device is configured to block actuation of the plurality of fasteners when the anti-theft device is active. A fourth example of the system, optionally including one or more of the previous examples, further includes where the anti-theft device is integrally arranged in one of the plurality of fasteners.

As used herein, the term “approximately” is construed to mean plus or minus five percent of the range unless otherwise specified.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A method, comprising:
operating an anti-theft device at a coupling between a traction motor and a driveline to signal to a controller to activate an alarm in response to unauthorized actuation of the coupling.

2. The method of claim 1, further comprising deactivating the anti-theft device by decoupling a wire from the controller, wherein the wire extends around a plurality of fasteners physically coupling the traction motor to the driveline.

3. The method of claim 1, further comprising deactivating the anti-theft device by disabling a proximity sensor coupled to the controller and configured to sense a proximity of a fastener physically coupled the traction motor to the driveline.

4. The method of claim 1, wherein operating the anti-theft device further comprises detecting actuation of the coupling and immobilizing the coupling responsive to tampering via a lock that is in a locked position.

5. The method of claim 1, further comprising deactivating the anti-theft device in response to a rate at which a fastener is actuated matching a threshold rate.

6. The method of claim 1, wherein operating the anti-theft device further comprises detecting tampering of the coupling in response to fasteners of the coupling being actuated when a vehicle comprising the traction motor is on a ground.

7. A system, comprising:
an axle housing;
a traction motor coupled to the axle housing via a plurality of fasteners;
an anti-theft device integrally arranged with the plurality of fasteners; and
a controller with computer-readable instructions stored on memory thereof that cause the controller to:
activate an alarm system in response to receiving a signal from the anti-theft device.

8. The system of claim 7, wherein the anti-theft device comprises a fastener and a lock, wherein the fastener comprises a slot configured to receive a key to unlock the lock and block the signal from the anti-theft device to the controller, and wherein the fastener is different than each of the plurality of fasteners.

9. The system of claim 7, wherein the anti-theft device comprises a fastener sized differently than each of the plurality of fasteners, and wherein the fastener is torqued to an upper threshold torque with a different tool relative to the plurality of fasteners.

10. The system of claim 7, wherein the anti-theft device comprises a cover configured to block access to the plurality of fasteners, the cover comprising an opening providing access to a fastener of the anti-theft device, where the fastener of the anti-theft device is different than each of the plurality of fasteners.

11. The system of claim 10, wherein the fastener comprises a key hole or is larger than each of the plurality of fasteners.

12. The system of claim 7, wherein the anti-theft device comprises a wire wrapped around the plurality of fasteners and electrically coupled to the controller.

13. The system of claim 12, wherein the instructions further cause the controller to maintain the alarm system inactive in response to the wire being decoupled from the controller, and wherein the controller receives the signal and activates the alarm system when one or more of the plurality of fasteners is actuated while the wire is coupled to the controller.

14. The system of claim 7, wherein the anti-theft device comprises a proximity sensor configured to sense a proximity of a fastener of the anti-theft device to the axle housing.

15. The system of claim 14, wherein the instructions further cause the controller to maintain the alarm system inactive in response to the proximity sensor being disabled and the fastener being actuated.

16. A system, comprising:
an axle housing;
a traction motor coupled to the axle housing via a plurality of fasteners;
an anti-theft device integrally arranged with the plurality of fasteners; and
a controller with computer-readable instructions stored on memory thereof that cause the controller to:
activate an alarm system in response to receiving a signal from the anti-theft device; and
maintain the alarm system inactive in response to the anti-theft device being disabled.

17. The system of claim 16, wherein the anti-theft device is disabled via one or more of a vehicle key, a key fob, a mobile device, a button in a vehicle interior, and an option provided by a display device of the vehicle.

18. The system of claim 17, wherein the anti-theft device comprises a component communicatively coupled to the controller, wherein the component is a fastener, a wire, or a proximity sensor.

19. The system of claim 16, wherein the anti-theft device is configured to block actuation of the plurality of fasteners when the anti-theft device is active.

20. The system of claim 16, wherein the anti-theft device is integrally arranged in one of the plurality of fasteners.
